(19) United States
(12) Patent Application Publication
(10) Pub. No.: US 2009/0044420 A1
(43) Pub. Date: Feb. 19, 2009

(54) Light directing hand dryer

(75) Inventor: Chi-Chin Hsu, Taipei County (TW)

Correspondence Address: Joe McKinney Muncy, PO Box 1364, Fairfax, VA, 22038-1364, US

(73) Assignee: Hokwang Industries Co., Ltd.

(21) Appl. No.: 11/889,743

(22) Filed: Aug. 16, 2007

(51) Int. Cl. F26B 19/00

(52) U.S. Cl. 34/88; 34/572

(57) ABSTRACT

A light directing hand dryer mainly includes a casing which has an air outlet and a light directing board exposed outside the casing. The casing houses an electric power unit, a sensor, a control switch and a blower. The blower has an airflow directing member corresponding to the air outlet, and at least one standby light and at least one operation light located on an outer side thereof. The standby light and operation light are located at one edge of the light direction board. The electric power unit provides required electric power to the hand dryer. The sensor can detect user's hands outside the casing so that the control switch can trigger the blower to operate and generate airflow, while the standby light and operation light generate light to be directed in the light directing board.

### FIELD OF THE INVENTION

The present invention relates to a light directing hand dryer and particularly to a light directing hand dryer that has lights that can be set ON and OFF to indicate use conditions.

### BACKGROUND OF THE INVENTION

Most hotels, restaurants or shopping sites have hand dryers installed at restrooms to enable customers to dry their hands after washing. This is a service provided to the customers so that they can keep their hands clean and dried even if they do not carry paper towels or handkerchieves.

U.S. Pat. No. 4,914,833 discloses an “Automatic hand dryer” which mainly includes a base mounted onto a wall. The base houses a blower, a sensor and a control circuit. The blower includes an air inlet, an air outlet, an air fan, a motor and a heater. The sensor can detect a detection zone outside the hand dryer so that the control circuit can trigger the heater to function. And the motor can drive the air fan to rotate to drive airflow to enter from the air inlet and pass through the heater, then discharge through the air outlet to form heated airflow. The control circuit calculates the continuous use time of the hand dryer. When the continuous use time exceeds a set time period (such as one minute), the control circuit forces the motor and heater to stop operation to avoid waste of electric power. Moreover, the hand dryer has a lighting device such as a light emitting diode to indicate use condition of the hand dryer.

### SUMMARY OF THE INVENTION

The primary object of the present invention is to provide a light directing hand dryer to dry user's hands as the conventional hand dryer does and also generate different colors of light so that the casing of the hand dryer can display selected luminous graphics and texts to facilitate commercial promotion.

Another object of the invention is to provide problem determination of the hand dryer to facilitate repairs and maintenance.

Yet another object of the invention is to provide user guides and illumination to save energy and facilitate environmental conservation.

To achieve the foregoing objects, the light directing hand dryer according to the invention mainly includes a casing which has an air outlet and a light directing board exposed outside the casing. The casing houses an electric power unit, a sensor, a control switch and a blower. The sensor is electrically connected to the electric power unit and the control switch. The blower has an airflow directing member corresponding to the air outlet, and at least one standby light and at least one operation light on an outer side thereof. The standby light and operation light are electrically connected to the control switch and located at one edge of the light directing board.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is a fragmentary exploded view of the invention.

FIG. 1B is a fragmentary enlarged view of the invention.

FIG. 2 is a schematic view of the invention showing a light travel path in a light directing board.

FIG. 3 is a perspective view of another embodiment of the invention.

FIGS. 4A and 4B are circuit block diagrams of the invention.

FIGS. 5A and 5B are schematic views of an embodiment of the invention.

### DETAILED DESCRIPTION OF THE PREFERRED EMBODIMENTS

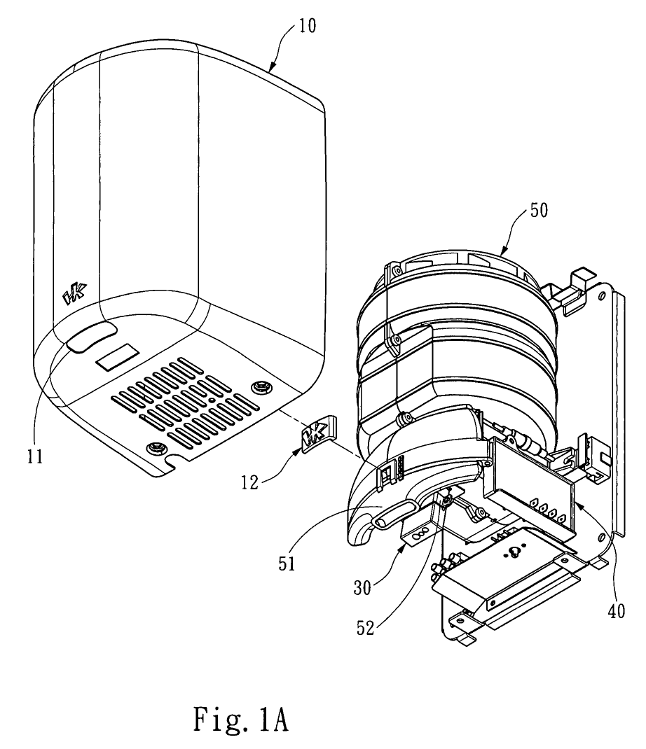

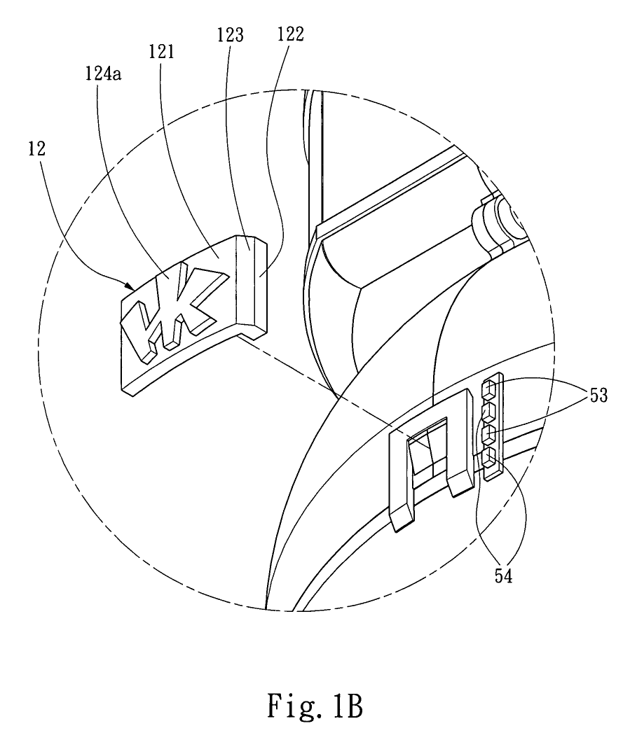

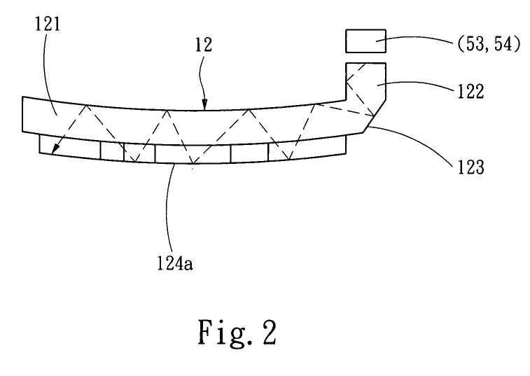

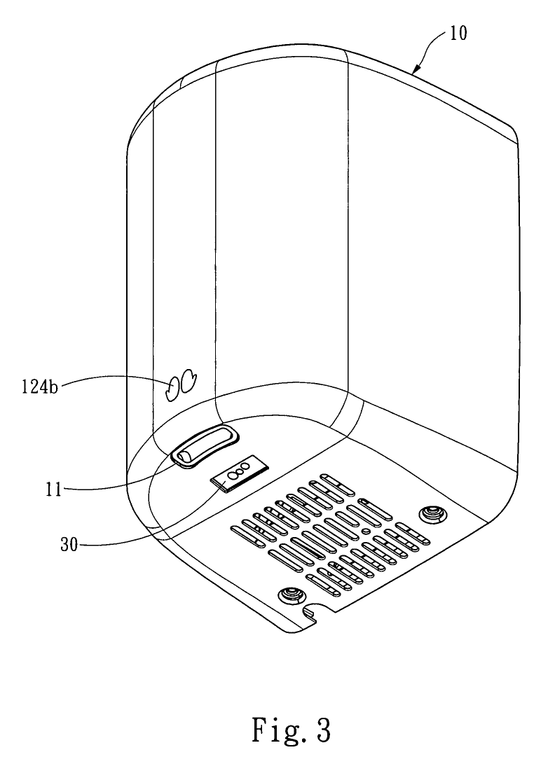

Please refer to FIGS. 1A and 1B, the hand dryer according to the invention mainly includes a casing 10 which houses an electric power unit 20 (not shown in the drawings), a sensor 30, a control switch 40 and a blower 50. The casing 10 has an air outlet 11 and a light directing board 12 exposed outside the casing 10. The blower 50 has an airflow directing member 51 corresponding to the air outlet 11. The airflow directing member 51 has a fastening plate 52 at one side to fasten the sensor 30 such that the sensor 30 is exposed outside the casing 10 and electrically connected to the electric power unit 20 (not shown in the drawings). The airflow directing member 51 further has at least one standby light 53 and at least one operation light 54 at another side. The standby light 53 and the operation light 54 are located on an outer side of the blower 50 and at one edge of the light directing board 12. The control switch 40 is located at one side of the blower 50 and electrically connected to the sensor 30, blower 50, standby light 53 and operation light 54 to control operation of the blower 50, standby light 53 and operation light 54. In an embodiment shown in the drawings, the standby light 53 and operation light 54 are light emitting diodes. The light directing board 12 (made from acrylic or the like) has a first light directing section 121 and a second light directing section 122 that are interposed by a light directing slope surface 123. The first light directing section 121 has a bulged display section 124a exposed outside the casing 10. The second light directing section 122 corresponds to the standby light 53 and operation light 54 so that light of the standby light 53 and operation light 54 can enter the second light directing section 122. The light is reflected a number of times and directed by the light directing slope surface 123 to enter the first light directing section 121 to evenly distribute in the light directing board 12 (as shown in FIG. 2), and project onto the display section 124a. The display section 124a may contain a text. When the light projects onto the display section 124a, the text becomes visible and can attract users' attention. Therefore a commercial promotion effect can be achieved. FIG. 3 illustrates another embodiment in which the display section 124b contains a graphic.

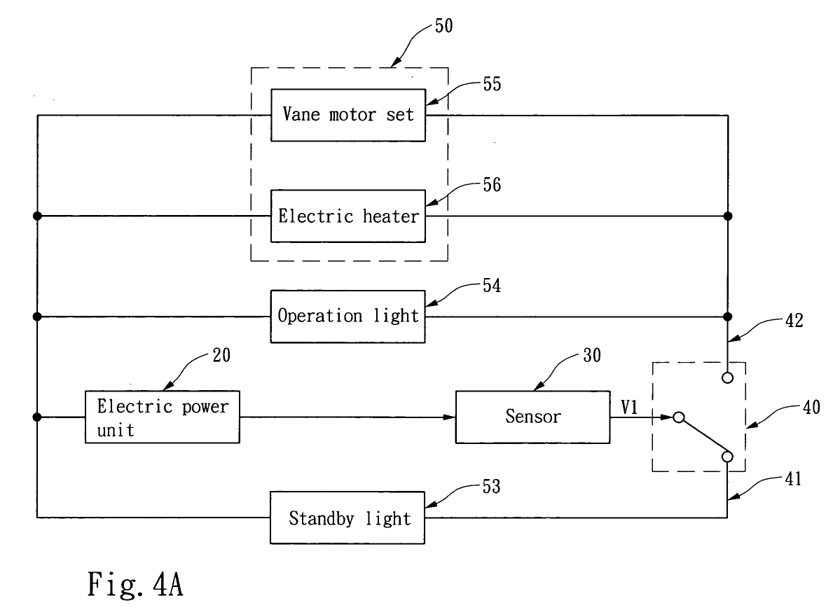

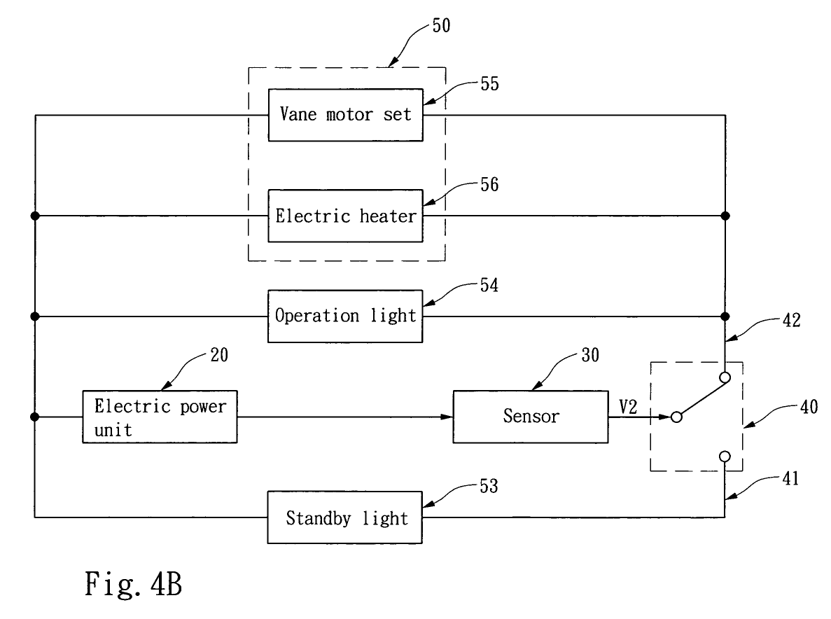

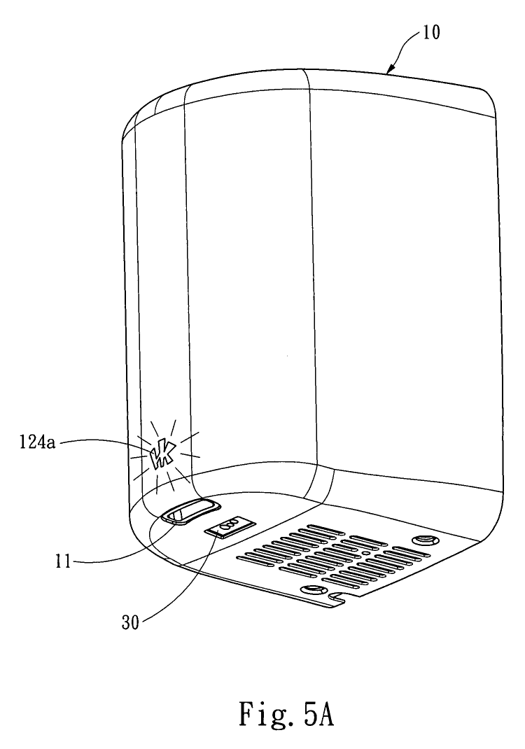

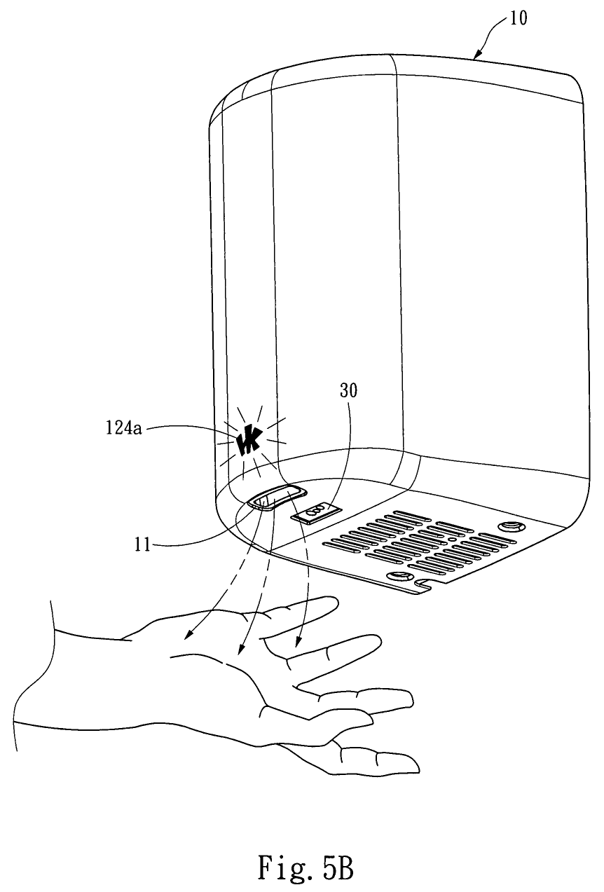

Refer to FIGS. 4A and 4B for the circuit block diagrams of the invention, and FIGS. 5A and 5B for an embodiment of the invention. The electric power unit 20 is connected to power (not shown in the drawings) to receive required power for the hand dryer. The sensor 30 can detect user's hands outside the casing 10, and transmit a standby signal V1 and an operation signal V2 to the control switch 40. The control switch 40 has a first circuit 41 and a second circuit 42 to receive respectively the standby signal V1 and the operation signal V2. The standby light 53 is located on the first circuit 41. The blower 50 and the operation light 54 are coupled with the second circuit 42 in a parallel manner. The blower 50 mainly includes a vane motor set 55 and an electric heater 56.

When not in use at regular time, the sensor 30 sends the standby signal V1 to the control circuit 40 to set the first circuit 41 ON and set the second circuit 42 OFF (referring to FIG. 4A) so that the standby light 53 emits light to illuminate the display section 124a through the light directing board 12 (referring to FIG. 5A). When the sensor 30 detects user's hands the operation signal V2 is sent to the control switch 40, and the second circuit 42 is set ON while the first circuit 41 is set OFF (referring to FIG. 4B). The vane motor set 55 is activated to drive airflow to pass through the electric heater 56 to generate heated airflow. The operation light 54 emits light to illuminate the display section 124a through the light directing board 12 (referring to FIG. 5B). The standby light 53 and the operation light 54 emit light of different colors to distinguish use conditions of the hand dryer. Through switch of colors the graphic or text shown on the display section 124a can attract more attention of users.

When both the standby light 53 and operation light 54 are OFF, it can be determined that the electric power unit 20 malfunctions. Thus repairs can be proceeded easier. Moreover, in an environment (such as a toilet) where no light is installed or the light is in an OFF condition, the light generated by the standby light 53 and operation light 54 can serve illumination and guiding purpose without turning ON other indoor lighting fixtures. Therefore it can save energy and is more environmental friendly. In short, the invention can provide the following benefits:
1. Different colors of light can be directed to the light directing board 12 from the standby light 53 and operation light 54 to evenly distribute to the display section 124a so that the standby or operation condition of the hand dryer can be indicated by the different colors of light to provide more effective visual effect and also facilitate commercial promotion to attract users' attention.
2. By setting ON or OFF of the standby light 53 and operation light 54, use condition of the hand dryer can be indicated, and problem causes can be determined easily to facilitate repairs and maintenance.
3. In an environment where indoor light is not turned on, the standby light 53 and operation light 54 generate light to illuminate the indoor environment and provide guiding function.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A light directing hand dryer, comprising:
a casing which has an air outlet and a light directing board exposed outside the casing;
an electric power unit located in the casing;
a sensor which is exposed outside the casing and electrically connected to the electric power unit;
a control switch which is located in the casing and electrically connected to the sensor; and
a blower which is located in the casing and has an airflow directing member corresponding to the air outlet and at least one standby light and at least one operation light located on an outer side thereof; the blower, the standby light and the operation light being electrically connected to the control switch; the standby light and the operation light being located at one edge of the light directing board.

2. The light directing hand dryer of claim 1, wherein the blower includes a vane motor set and an electric heater.

3. The light directing hand dryer of claim 1, wherein the light directing board is made from acrylic.

4. The light directing hand dryer of claim 1, wherein the light directing board has a first light directing section and a second directing section that are interposed by a light directing slope surface.

5. The light directing hand dryer of claim 4, wherein the first light directing section has a bulged display section exposed outside the casing.

6. The light directing hand dryer of claim 5, wherein the display section contains a text.

7. The light directing hand dryer of claim 5, wherein the display section contains a graphic.

8. The light directing hand dryer of claim 1, wherein the sensor is fastened to one side of the airflow directing member through a fastening plate.

9. The light directing hand dryer of claim 1, wherein the standby light is a light emitting diode.

10. The light directing hand dryer of claim 1, wherein the operation light is a light emitting diode.
